(19) United States
(12) Patent Application Publication
(10) Pub. No.: US 2026/0076295 A1
(43) Pub. Date: Mar. 19, 2026

(54) BROADFORK ASSEMBLY

(71) Applicant: Josh Riley, Mayfield, KY (US)

(72) Inventor: Josh Riley, Mayfield, KY (US)

(21) Appl. No.: 19/330,816

(22) Filed: Sep. 16, 2025

Related U.S. Application Data
(60) Provisional application No. 63/695,138, filed on Sep. 16, 2024.

(51) Int. Cl. A01D 9/02; A01D 9/04; B25G 3/26

(52) U.S. Cl. CPC A01D 9/02; A01D 9/04; B25G 3/26

(57) ABSTRACT

A broadfork assembly includes a longitudinal crossbar including a plurality of transverse slots for cooperatively engaging a plurality of removable fork tines. A handle having a pair of spaced apart aligned tubular members cooperatively engages a pair of sockets mounting to a top surface of the longitudinal crossbar. The handles include a transverse hole in the bottom distal end. Removably affixed to the longitudinal crossbar is a plurality of removable forks. The top blade portion includes a top edge having a lug for cooperative engagement with one of the slots in the longitudinal crossbar. The longitudinal crossbar includes a pair of ends or end caps having a center hole therein for insertion of a rod which extends through the handles and a transverse hole in the top blade portion of the curved blades running parallel to the longitudinal crossbar. The rod includes retainer means on each of its distal ends.

### TECHNICAL FIELD OF THE INVENTION

The present invention relates to tools and more particularly a broadfork.

### CROSS REFERENCES TO RELATED APPLICATIONS

This application claims priority from U.S. Provisional Application Ser. No. 63/695,138 filed on Sep. 16, 2024, which is incorporated by reference herein in their entirety.

### BACKGROUND OF THE INVENTION

The broadfork is a garden and landscape tool used to pry and manually break-up densely packed soil, including hard pan, to improve aeration and drainage or by fireman for breaking up soil as a fire break. Broadforks preserve the soil structure and avoid the resurfacing of weed seeds by breaking up the soil. The forks have a plurality of metal tines, usually from six to twelve inches long spaced apart a few inches apart on a horizontal crossbar, with handle means extending upwards to the chest or shoulder level.

The user typically pushes the tines into the ground and steps on the crossbar using their full body weight to drive the tines into the ground and steps backward while pulling backwards on the handle causing the tines to pivot upwards prying up the soil. The procedure can be used to pry up chunks of soil leaving the soil layers intact, rather than inverting or mixing the soil preserving the top soil structure.

Longer tines from 12 to 24 inches can be utilized for deeper cultivation in beds with sandy, loamy or loose soil which has been worked previously.

### SUMMARY OF THE INVENTION

The present invention utilizes a collapsible broadfork kit including a fork having curved blades and handles attaching to a crossbar. The handles and fork blades are removable without the use of tools and can be stored or transported in a 4 inch by 4 inch×48 inch container such as a box. The broadfork allows the tines to penetrate the soil and be pushed downward then pried upward when the handle(s) are tilted back. Clumps of soil caught on the tines can be broken up by rocking or shaking the tool.

The present invention provides a broadfork assembly which can be assembled and disassembled without tools for convenient transport and storage and is available as a kit. The broadfork assembly comprises or consists of a handle removably connecting at its bottom end to a frame defining a longitudinal crossbar. In one preferred embodiment, the handle means comprises a pair of spaced apart aligned handles approximately 48 inches in length. The longitudinal crossbar comprises a tubular member having a fork comprising a plurality of removable tines defining curved blades extending downward at a selected angle. The longitudinal crossbar may have a cross sectional shape that is square, rectangular or even round. The longitudinal crossbar has a cross-sectional shape selected from the group consisting of a square cross section, a rectangular cross-section, and a round cross section. The fork in the preferred embodiment comprise curved blades of uniform thickness having a generally flat top edge and a tapered bottom portion terminating in a point. The top end portions of the curved forks form a rectangular end portion or head including an offset on the front and rear edge of the head forming a shoulder at the front and rear of the blade which rests against a side panel or an edge of the longitudinal crossbar with the upper rectangular portion being disposed within the crossbar housing or slots formed in the bottom surface of the longitudinal crossbar. Each blade includes a rectangular lug projecting from the head which is insert able in a slot formed in the top surface of the longitudinal crossbar. The slots formed in the top surface of the longitudinal crossbar cooperatively engaging the head lug are of corresponding size and shape in order to align and space the removable curved blades at selected intervals. A rod is inserted through the distal ends or end caps of the longitudinal crossbar, through transverse holes in the handles and transverse holes formed in the sides of the head of the curbed blades to aid in supporting and removably retaining the heads of the fork within the longitudinal crossbar.

More particularly, the collapsible broadfork assembly kit, comprises or consists of a longitudinal crossbar including a plurality of transverse slots and a handle socket hole on the top surface near each end. A handle having a pair of spaced apart aligned tubular members cooperatively engages a pair of sockets mounting to a top surface of the longitudinal crossbar. The handles include a transverse hole in the bottom distal end. Removably affixed to the longitudinal crossbar is a fork having a plurality of removable curved blades, each one having a tapered point and a top blade portion forming a rectangular end portion offset slightly from the curved blade portion forming a shoulder at a front edge and rear edge of the curved blade resting against a front panel and a rear panel of the longitudinal crossbar for adjusting the angle of the curved blade and for structural support. The top blade head portion includes a top edge having a lug for cooperative engagement with one of the slots in the longitudinal crossbar for aligning and spacing the forks along the longitudinal crossbar. The top blade head portion includes a transverse hole therethrough. The longitudinal crossbar includes opposing ends or end caps having a center hole therein for insertion of a rod which extends through the transverse holes in the handles and the transverse holes in the top blade head portion of the curved blades running parallel to the longitudinal crossbar. The rod includes retainer means on each of its distal ends.

More particularly, the broadfork assembly comprises or consists of a longitudinal crossbar having a top panel and a bottom panel connected by a front panel and a rear panel. A pair of spaced apart aligned handles having distal ends removably connecting to the longitudinal crossbar. The crossbar including a plurality of spaced apart slots formed therein. A plurality of fork tines are removably affixed to the longitudinal crossbar, each fork tine comprising a head portion configured for insertion into a corresponding slot formed in the longitudinal crossbar. The fork tine includes a blade portion extending downward from the head portion, the blade portion being curved and tapered terminating in a distal point. A shoulder formed at the intersection of the head portion and the blade portion abuts an edge of the longitudinal crossbar. A projection extends from a top edge of the head portion for cooperative engagement with the slot formed in the longitudinal crossbar. A rod extends axially through opposing end caps of the longitudinal crossbar. The end caps have holes therein for cooperatively engaging the rod. The rod extending through transverse holes formed in a distal end of each of the handles. The rod extends through transverse holes formed in the head portion of the fork tines. The rod includes retainer means for securing the rod in place within the longitudinal crossbar comprising a transverse slot or hole for receiving a pin such as a lynch pin. The fork tines are removably affixed to the longitudinal crossbar without the use of tools, nuts, or bolts. The crossbar includes a pair of sockets for cooperatively engaging the handles removably inserted in the longitudinal crossbar.

A novel feature of the present invention is the use of interlocking parts so that the broadfork can be assembled and disassembled without the use of tools and breaks down into components without any nuts or bolts. The preferred embodiment described herein can be assembled and disassembled without any nuts and bolts and contained in a 4 inch×4 inch×48 inch bag or box to be transported, stored, or shipped.

It is an object of the present invention to provide a fork having a selected width of 12, 18, 20, 24, 30, or 36 inches wide or any desired custom width and a plurality of fork tines depending upon the desired width of the fork and spacing between the tines.

It is an object of the present invention to provide a fork having a selected lengths in a range or from 6 to 24 inches, more particularly from 10 to 18 inches, and more particularly form 12 to 14 inches.

It is an object of the present invention that the fork material be formed from AR400 steel, AS400 steel, mild steel, aluminum, copper, stainless steel, or carbon fiber custom material.

It is an object of the present invention that the pin material be composed from stainless steel and have a cross sectional shape of round, oval, square, rectangular, hexagonal, or triangular shape.

It is an object of the present invention to provide a broadfork having a plurality of fork tines whereby individual fork tines can be removed without tools to vary spacing there between.

It is an object of the present invention to provide the forks and the handles to be removably affixed to the crossbar in order that forks and handles of different lengths, shapes or sizes can be utilized for particular purposes.

It is an object of the present invention that a pair of handles be formed of steel, wood, fiberglass, aluminum, composite material or combinations thereof and be of selected length of 36, 42, 48, 60, inches long or of a custom length.

It is an object of the present invention that it be assembled or disassembled as a kit without requiring tools.

It is an object of the present invention that the frame crossbar comprise a rectangular tubular member.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is an isometric view of an assembled broadfork;

FIG. 2 is an exploded isometric view of the broad fork of FIG. 1 unassembled;

FIG. 3 is a rear view of FIG. 1;

FIG. 4 is a right side view of FIG. 1;

FIG. 5 is a top view of the crossbar and fork of FIG. 1;

FIG. 6 is a bottom view of the crossbar and fork FIG. 1;

FIG. 7 is a top view of the crossbar of FIG. 1;

FIG. 8 is a top view of the crossbar showing the lugs of the curved blade head projecting through slots formed in the top of the crossbar of FIG. 1;

FIG. 9 is a right side view of the crossbar of FIG. 1 showing the end cap and rod therethrough;

FIG. 10 is a left side view of a curved blade which inserts into the crossbar;

FIG. 11 is a front view of a curved blade which inserts into the crossbar;

FIG. 12 is a top view of a tine which inserts into the crossbar;

FIG. 13 is a right side view of the handle showing a transverse hole on the distal end which inserts into the handle receiver socket of the crossbar;

FIG. 14 is a top side view of the rod having axial pin holes on each distal end which inserts into the crossbar holding the handle and forks in place; and

FIG. 15 is a isomeric view of a spring pin which inserts into the pin holes of the rod.

### DETAILED DESCRIPTION OF THE PREFERRED EMBODIMENT

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The information included in this section, data or specifications, including any references cited herein and any description or discussion thereof, is included for exemplary purpose only and is not to be regarded as subject matter by which the scope of the invention as defined in the claims appended hereto is to be bound.

The description of the exemplary embodiments according to principles or spirits of the present invention is intended to be read in connection with the accompanying drawings, which are to be regarded as part of the entire written description. In the description of the embodiments of the invention disclosed herein, for describing precisely and concisely, each element in the drawings is assigned a reference number in most cases in term of its feature corresponding the claims append unless expressly described otherwise, e.g., if a valve is claimed, no matter the valve is a ball valve, a membrane valve, or poppet valve in an exemplary embodiment, the valve members or valve seats in different drawings are assigned one element reference number unless expressly described otherwise.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

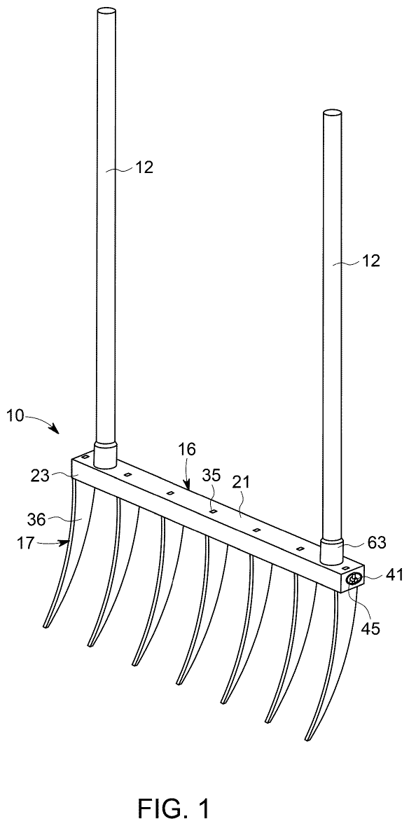

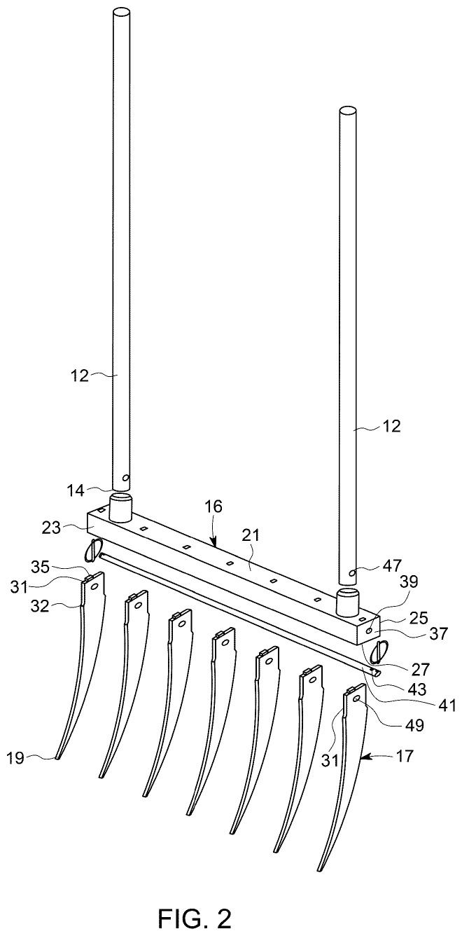

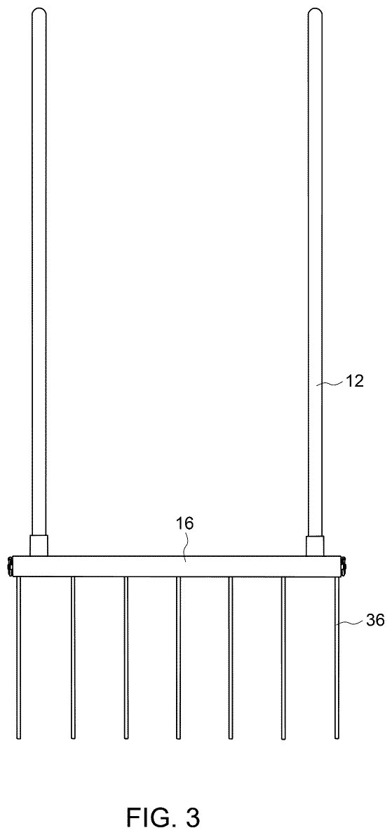

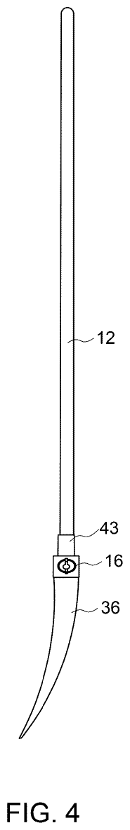

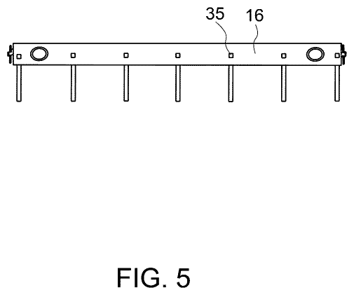

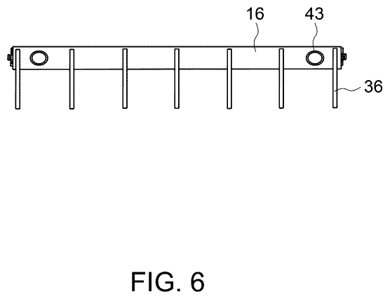

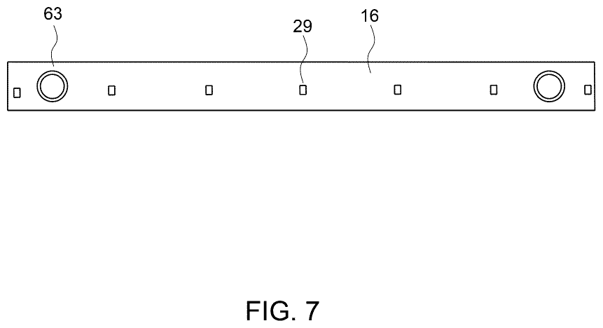

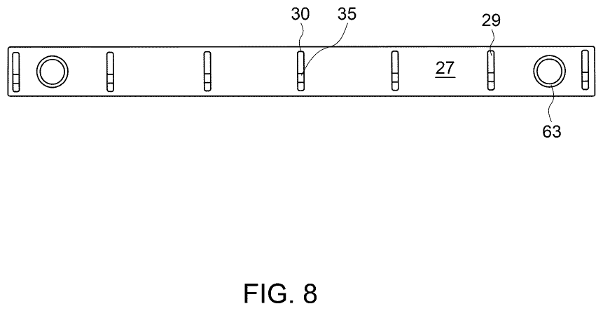

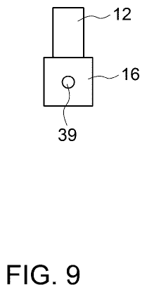

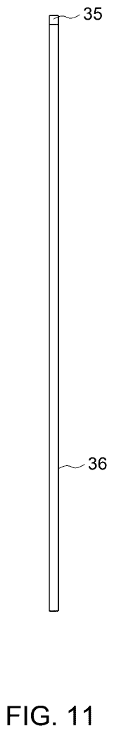

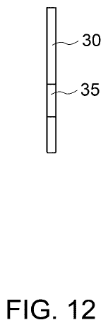

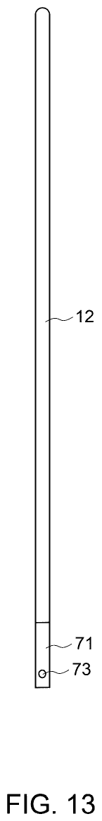

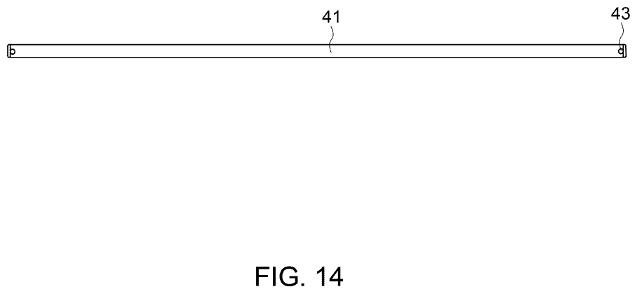

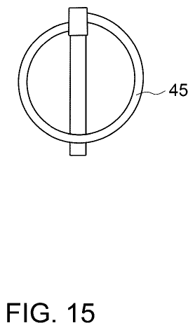

As shown in FIGS. 1-15, the present invention comprises or consists of a broadfork assembly 10 having a pair of spaced apart aligned handles 14 removably connecting at its bottom distal end 14 to a frame defining a longitudinal crossbar 16. A preferred embodiment has a 24 inch body or crossbar and seven spaced apart aligned fork tines 17 of a selected width, for instance, 10, 12, or 14 inches in length which are removably affixed to the crossbar and can be changed without the use of tools and requires no nuts or bolts.

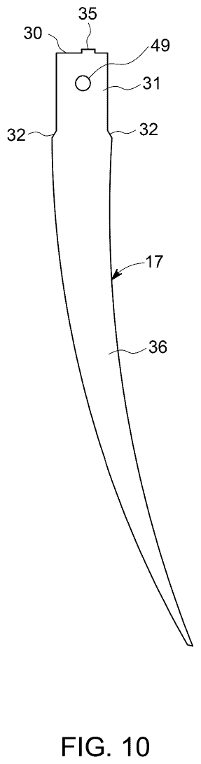

The longitudinal crossbar 16 cooperatively engages a plurality of removable curved fork tines which may define blades. In one preferred embodiment, the blades 17 are curved having a narrower width from top to bottom and a pointed distal end 19. The longitudinal crossbar 16 may be a tubular member and/or may have a cross sectional shape that is square, rectangular or even round. The rectangular longitudinal crossbar 16 includes a top panel 21 connected by a pair of opposing side panels, a front panel 23 and a rear panel 25. A bottom panel 27 may include a plurality of slots 29 for insertion of a top portion or head 31 of the fork tines 17 for aligning and spacing the fork tines 17 apart from one another, and/or may include means for adjusting the angle of the curved blades or tines 17 such as the angle of the top portion or head 31 of the fork tines 17 or with the use of spacers insertable on the top or sides of the top portion 31 of the fork tines 17. As shown in the FIG. 10, a shoulder 32 is formed at the intersection of the head portion 31 and the blade portion 36 of the fork tine. Grooves or slots 29 formed in the top surface of the longitudinal crossbar 16 are of corresponding size and shape to cooperatively engage the top portion 31 of the fork tines 17 in order to align and space the curved blades at selected intervals. The slots 33 of a reduced dimension are formed in the top panel 21 in alignment with the slots in the bottom panel 27 to cooperatively engage a point or projection 35 extending from the top edge 30 of the head portion 31 for cooperative engagement with the slots 29 formed in the top portion 21 of the longitudinal crossbar 16. The longitudinal crossbar 16 includes and opposing end plates 37 or has end caps 37 having holes 39 therein for insertion of a rod 41 therethrough running parallel to the longitudinal crossbar 16. The rod 41 includes retainer means such as a transverse slot or hole 43 for cooperative engagement with a lynch pin or other pin 45 formed of stainless steel, steel, or aluminum in a round, square, rectangle, hex, or triangle shape. The top surface 21 of the longitudinal crossbar 16 provides a foot support plate. The crossbar 16 may be fabricated from a single bar or material, molded or forged as a single piece or formed by welding panels or strips of material together.

A rod 41 is inserted through the holes 39 formed in the distal ends caps 37 of the longitudinal crossbar 16, thorough transverse holes 47 in the distal ends 14 of the handles 12, and through transverse holes 49 formed in the sides of the head 31 of the curved blade fork tine 17 to aid in removably supporting and retaining the heads 31 of the curved blades portion 36 of the fork tines 17 extending from the longitudinal crossbar 16.

The fork may comprise fork tines 17 having curved or straight tapered prongs, cylindrical prongs, or curved blades as illustrated in the preferred embodiment of uniform thickness having a generally flat top edge and a tapered bottom portion terminating in a point. The top end portions of the curved blades form a rectangular end portion offset slightly from the curved blade portion of the forks forming a shoulder 32 at the front and rear of the blade and rests against an edge of the bottom surface or a side panel of the longitudinal member. The top end portion of the curved blade disposed within slots formed in the bottom surface of the crossbar of the longitudinal crossbar includes a rectangular lug 35 projecting from the head 31 having a top flat edge 30 of each of the curved blades which are insertable and mount in corresponding shaped and sized slots 29 formed in the top surface of the longitudinal crossbar 16.

Handle means are removably affixed to the longitudinal member. The handle means comprises a pair of spaced apart aligned handles 12 approximately 48 inches in length; however, the length is not critical. A socket 63 is affixed to the top surface of the transverse longitudinal member at each one of its distal ends 71. The ends of the handles are removably inserted or held within the sockets and may be mounted in the socket or extend through the socket into the longitudinal crossbar where a rod can be disposed through a transverse hole 73 formed in the distal end of the handle and held within the longitudinal crossbar cooperatively engaging the rod. The distal ends of the handles extend through the sockets and the top surface of the transverse longitudinal member 16 and the transverse bores cooperatively engaging the rod.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A collapsible broadfork kit, consisting of:
a longitudinal crossbar including a plurality of transverse slots and a handle socket and hole on the top surface near each end:
a handle comprising a pair of spaced apart aligned tubular members cooperatively engaging a pair of sockets mounting to a top surface of said longitudinal crossbar, said handles including a transverse hole in the bottom distal end;
a plurality of removable forks each one having a curved blade with a tapered point and a top blade portion forming a rectangular end portion offset slightly from the curved blade portion forming a shoulder at a front edge and rear edge of said curved blade resting against a front panel and a rear panel of said longitudinal crossbar and said top blade portion including a top edge having a lug for cooperative engagement with one of said slots in said longitudinal crossbar for aligning and spacing said forks along said longitudinal crossbar, said top blade portion including a transverse hole therethrough; and
said longitudinal crossbar including a pair of end caps having a center hole therein for insertion of a rod extending through said handles and said top blade portion of said curved blades running parallel to said longitudinal crossbar, said rod including retainer means on each of its distal ends.

2. A broadfork assembly, consisting of:
a longitudinal crossbar having a top panel and a bottom panel connected by a front panel and a rear panel;
a pair of spaced apart aligned handles having distal ends removably connecting to said longitudinal crossbar, said crossbar including a plurality of spaced apart slots formed therein;
a plurality of fork tines removably affixed to said longitudinal crossbar, each fork tine comprising:
a) a head portion configured for insertion into a corresponding slot formed in said longitudinal crossbar;
b) said fork tine including a blade portion extending downward from said head portion, said blade portion being curved and tapered terminating in a distal point;
c) a shoulder formed at the intersection of said head portion and said blade portion abutting an edge of said longitudinal crossbar;
d) a projection extending from a top edge of said head portion for cooperative engagement with said slot formed in said longitudinal crossbar;
a rod extending axially through opposing end caps of said longitudinal crossbar, said end caps having holes therein for cooperatively engaging said rod;
said rod extending through transverse holes formed in a distal end of each of said handles;
said rod extending through transverse holes formed in said head portion of said fork tines;
said rod including retainer means for securing said rod in place within said longitudinal crossbar comprising a transverse slot or hole for receiving a pin;
said fork tines are removably affixed to said longitudinal crossbar without the use of tools, nuts, or bolts; and
said crossbar including a pair of sockets for cooperatively engaging said handles removably inserted in said longitudinal crossbar.

3. The broadfork assembly of claim 2, wherein said longitudinal crossbar has a cross-sectional shape selected from the group consisting of a square cross section, a rectangular cross-section, and a round cross section.

4. The broadfork assembly of claim 2 wherein said fork tine is curved and tapered from a wider top portion to a pointed distal end.

5. The broadfork assembly of claim 2, wherein aid fork tine head includes a rectangular lug extending from a top edge of said fork tine head for cooperative engagement with a corresponding sized and shaped slot formed in said longitudinal crossbar.

6. The broadfork assembly of claim 2 wherein said fork tines are spaced apart at uniform intervals along said longitudinal crossbar.

7. The broadfork assembly of claim 2, wherein said longitudinal crossbar is configured to allow adjustment of an angle of said fork tine with respect to said crossbar by using spacers.

8. The broadfork assembly of claim 2 wherein said distal ends of said handles are removably inserted into sockets having transverse holes therein and are affixed to a top surface of said longitudinal crossbar.

9. The broadfork assembly of claim 8, wherein said distal ends are secured by said rod passing through a transverse hole in said sockets and said handles.
